(19) United States
(12) Patent Application Publication
(10) Pub. No.: US 2023/0159023 A1
(43) Pub. Date: May 25, 2023

(54) METHOD AND ELECTRONIC APPARATUS FOR PREDICTING PATH BASED ON OBJECT INTERACTION RELATIONSHIP

(71) Applicant: Industrial Technology Research Institute, Hsinchu (TW)

(72) Inventors: Huei-Ru Tseng, New Taipei City (TW); Ching-Hao Liu, Kaohsiung City (TW); An-Kai Jeng, Hsinchu City (TW)

(73) Assignee: Industrial Technology Research Institute, Hsinchu (TW)

(21) Appl. No.: 17/563,072

(22) Filed: Dec. 28, 2021

(30) Foreign Application Priority Data
Nov. 23, 2021 (TW) 110143485

(51) Int. Cl. B60W 30/09; G06V 20/40; G06V 20/58; G06T 7/73; G06V 10/40; G08G 1/16; B60W 30/095; B60W 60/00

(52) U.S. Cl. CPC B60W 30/09; G06V 20/40; G06V 20/58; G06T 7/73; G06V 10/40; G08G 1/16; B60W 30/0956; B60W 60/0015; G06T 2207/30241; G06T 2207/30261; B60W 2552/53

(57) ABSTRACT

A method and an electronic apparatus for predicting a path based on an object interaction relationship are provided. The method includes the following. A video including a plurality of image frames is received. Object recognition is performed on a certain image frame among the plurality of image frames to recognize at least one object in the certain image frame. Preset interactive relationship information associated with the at least one object is obtained from an interactive relationship database based on the at least one object. A first trajectory for navigating the first vehicle is determined based on the preset interactive relationship information.

### CROSS-REFERENCE TO RELATED APPLICATION

This application claims the priority benefit of Taiwan application serial no. 110143485, filed on Nov. 23, 2021. The entirety of the above-mentioned patent application is hereby incorporated by reference herein and made a part of this specification.

### BACKGROUND

### Technical Field

The disclosure relates to an autonomous driving decision-making technology, and in particular to a method and an electronic apparatus for predicting a path based on an object interaction relationship.

### Description of Related Art

With the vigorous development of science and technology, research on autonomous driving is thriving. Currently, an autonomous vehicle analyzes a large number of information in real time to realize effective self-driving. For example, an autonomous vehicle needs to accurately analyze data such as map information or surrounding objects during operation. The analysis results of these data are used as the basis for controlling the driving of the autonomous vehicle, so that the decision of the autonomous vehicle in the event of an emergency is similar to the behavior of a human driver.

However, the decision-making ability of autonomous driving has an effect on the safety of the autonomous vehicle. Once a decision of autonomous driving is wrong, serious problems such as traffic accidents may occur. Therefore, improving the accuracy of decision making in autonomous driving is an important issue to those skilled in the art.

### SUMMARY

The disclosure provides a method and an electronic apparatus for predicting a path based on an object interaction relationship, which improve the accuracy of predicting a trajectory of an object around a main vehicle.

A method for predicting a path based on an object interaction relationship of the disclosure is adapted for an electronic apparatus including a processor. The processor is configured to control a first vehicle. The method includes the following. A video including multiple image frames is received. Object recognition is performed on a certain image frame among the plurality of image frames to recognize at least one object in the certain image frame.

Preset interactive relationship information associated with the at least one object is obtained from an interactive relationship database based on the at least one object. A first trajectory for navigating the first vehicle is determined based on the preset interactive relationship information.

An electronic apparatus of the disclosure is adapted for controlling a first vehicle. The electronic apparatus includes a storage device and a processor. The storage device stores an interactive relationship database. The processor is coupled to the storage device, and the processor is configured to: receive a video including multiple image frames; perform object recognition on a certain image frame among the plurality of image frames to recognize at least one object in the certain image frame; obtain preset interactive relationship information associated with the at least one object from the interactive relationship database based on the at least one object; and determine a first trajectory for navigating the first vehicle based on the preset interactive relationship information.

Based on the above, in the method and the electronic apparatus for predicting a path based on an object interaction relationship provided by the embodiment of the disclosure, the predicted trajectory of the predicted object is generated based on the preset interactive relationship information between the objects. The predicted trajectory is used to determine the trajectory for navigating the main vehicle. In this way, the predicted trajectory of the predicted object is generated by considering the preset interactive relationship between the objects. The disclosure reduces the trajectory prediction error of the object around the main vehicle. Based on the above, the accuracy of predicting the trajectory of the object around the main vehicle is improved, and the trajectory for navigating the main vehicle is accurately planned.

To provide a further understanding of the above features and advantages of the disclosure, embodiments accompanied with drawings are described below in details.

### BRIEF DESCRIPTION OF THE DRAWINGS

FIG. 1 illustrates a block diagram of a path prediction system based on an embodiment of the disclosure.

FIG. 2 illustrates a flow chart of a method for predicting a path based on an object interaction relationship based on an embodiment of the disclosure.

FIG. 3 illustrates a schematic view of object recognition based on an embodiment of the disclosure.

FIG. 4 illustrates a schematic view of an object interactive relationship based on an embodiment of the disclosure.

FIG. 5 illustrates a flow chart of a method for predicting a path based on an object interaction relationship based on an embodiment of the disclosure.

FIG. 6 illustrates a schematic view of an object interactive relationship based on an embodiment of the disclosure.

FIG. 7 illustrates a schematic view of an object interactive relationship based on an embodiment of the disclosure.

FIG. 8 illustrates a flow chart of a method for predicting a path based on an object interaction relationship based on an embodiment of the disclosure.

### DESCRIPTION OF THE EMBODIMENTS

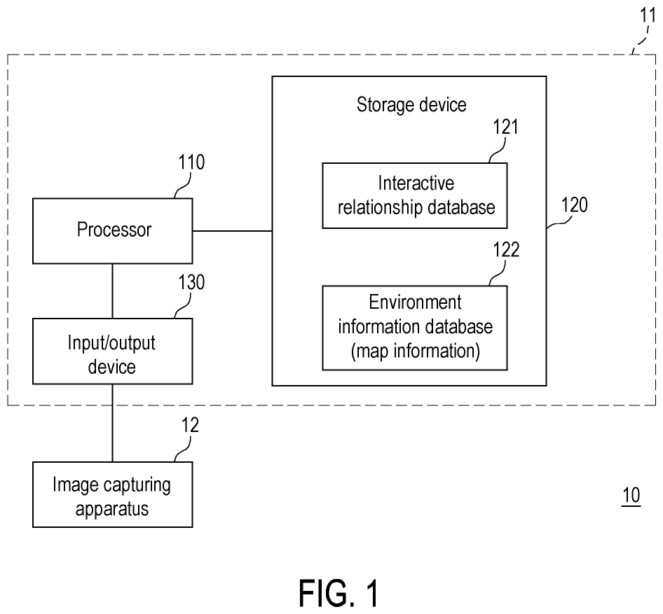

FIG. 1 illustrates a block diagram of a path prediction system based on an embodiment of the disclosure. Referring to FIG. 1, a path prediction system 10 includes an electronic apparatus 11 and an image capturing apparatus 12. The electronic apparatus 11 includes but is not limited to include a processor 110, a storage device 120, and an input/output (I/O) device 130. The electronic apparatus 11 of this embodiment is, for example, a device that is disposed on a vehicle and has arithmetic functions. However, the electronic apparatus 11 may also be a remote server to remotely control the vehicle, and the disclosure is not limited thereto.

The processor 110 is coupled to the storage device 120 and the input/output device 130. The processor 110 is, for example, a central processing unit (CPU), or other programmable general-purpose or special-purpose devices such as a microprocessor, a digital signal processor (DSP), a programmable controller, application specific integrated circuits (ASIC), a programmable logic controller (PLC), or other similar devices or a combination of these devices. The processor 110 loads and performs the program stored in the perform storage device 120 to perform the method for predicting a path based on an object interaction relationship based on the embodiment of the disclosure.

The storage device 120 is, for example, any type of fixed or removable random access memory (RAM), read-only memory (ROM), flash memory, hard disk, or a similar element or a combination of the above elements. The storage device 120 is used to store the program and data that may be performed by the processor 110. In an embodiment, the storage device 120 stores an interactive relationship database 121 and an environment information database 122. In addition, the storage device 120 also stores, for example, a video received by the input/output device 130 from the image capturing apparatus 12.

The input/output device 130 is a wired or wireless transmission interface such as a Universal Serial Bus (USB), RS232, Bluetooth (BT), and Wireless fidelity (Wi-Fi). The input/output device 130 is used to receive a video provided by an image capturing apparatus such as a camera.

The image capturing apparatus 12 is used to extract an image in front of it. The image capturing apparatus 12 may be a camera that adopts a charge coupled device (CCD), a complementary metal-oxide semiconductor (CMOS) element, or other element lenses. In this embodiment, the image capturing apparatus 12 may be disposed in a main vehicle (also known as a first vehicle), and disposed to extract a road image in front of the main vehicle. It is worth noting that this main vehicle is a vehicle controlled by the processor 110.

In an embodiment, the electronic apparatus 11 may include the above-mentioned image capturing apparatus, and the input/output device 130 is a bus used to transmit data within the device, and the video captured by the image capturing apparatus may be transmitted to the processor 110 for processing. The embodiment is not limited to the above architecture.

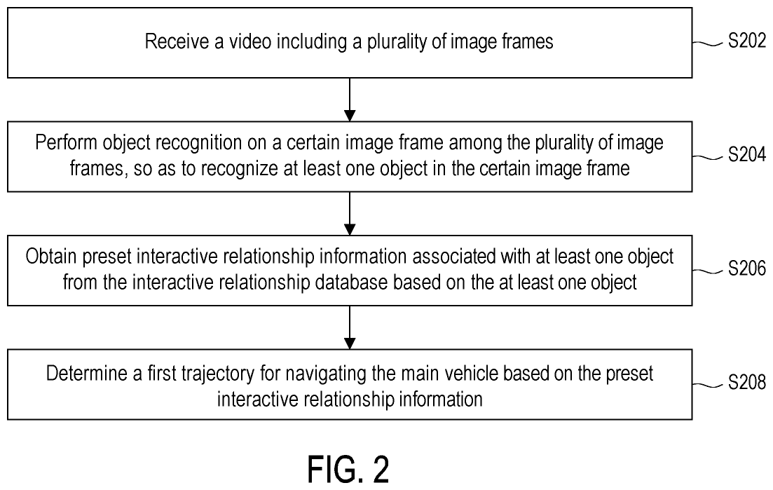

FIG. 2 illustrates a flow chart of a method for predicting a path based on an object interaction relationship based on an embodiment of the disclosure. Referring to FIG. 1 and FIG. 2, the method of this embodiment is adapted to the above-mentioned electronic apparatus 11. The following is detailed steps of the method for predicting a path based on an object interaction relationship of this embodiment in connection with the elements of the electronic apparatus 11.

First, in step S202, the processor 110 may receive a video including a plurality of image frames. Specifically, the processor 110 receives the video including the plurality of image frames from the image capturing apparatus 12 by using the input/output device 130.

In step S204, the processor 110 may perform object recognition on a certain image frame among the plurality of image frames, so as to recognize at least one object in the certain image frame. In an embodiment, the processor 110, for example, performs object detection and a recognition algorithm on the certain image frame to recognize the object in the certain image frame. For example, the processor 110 extracts features in the certain image frame and recognizes the object by using a pre-established and trained object recognition model. The object recognition model is a machine learning model established through, for example, a convolutional neural network (CNN), deep neural networks (DNN), or other types of neural networks combined with a classifier. The object recognition model learns from a large number of input images, and may extract the features in the image and classify these features to recognize the object corresponding to a specific object type. Those skilled in the art should know how to train the object recognition model that may recognize the object in the certain image frame.

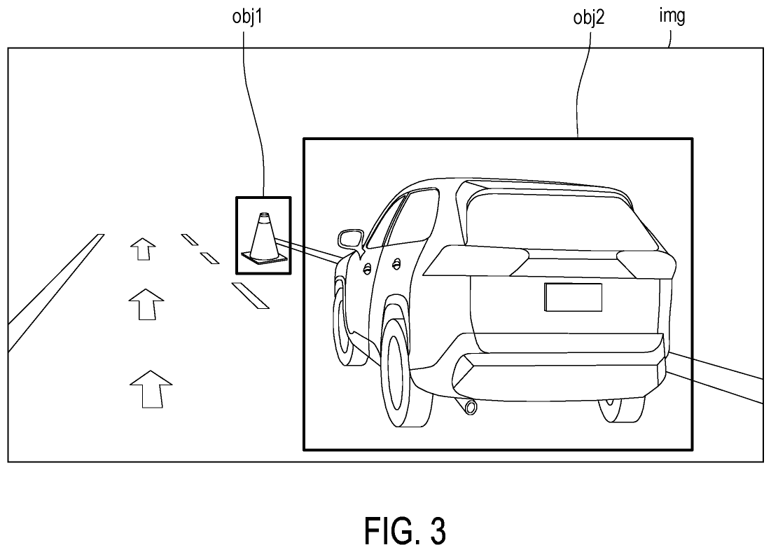

For example, FIG. 3 illustrates a schematic view of object recognition based on an embodiment of the disclosure. Referring to FIG. 3, the processor 110 may obtain an image frame img through the image capturing apparatus 12, and the image frame img is the road image in front of the main vehicle. After the processor 110 performs object recognition on the image frame img, the processor 110 may recognize an object obj1 and an object obj2. In this embodiment, the processor 110 may classify the object obj1 as a traffic cone and classify the object obj2 as a vehicle by using the object recognition model. It is worth mentioning that the processor 110 may also analyze the image content of the plurality of image frames to obtain the distance between the main vehicle and the object in the image frame, the distance between the plurality of objects in the image frame, and the movement velocity of the object. For example, the processor 110 may analyze the image content of the plurality of image frames to obtain the distance between the main vehicle and the object obj1 or the object obj2 in FIG. 3, the distance between the object obj1 and the object obj2, or the movement velocity of the object obj2. However, the above-mentioned technical concept related to analyzing distance and velocity by using the image content of image frames is a common technical method to those skilled in the art and will not be repeated herein.

In step S206, the processor 110 may obtain preset interactive relationship information associated with at least one object from the interactive relationship database 121 based on the at least one object. In this embodiment, the preset interactive relationship information between the plurality of preset objects may be included in the interactive relationship database.

In an embodiment, the preset object may refer to a certain traffic object in the road image, and the preset interactive relationship information may refer to the object interactive relationship among a plurality of certain traffic objects. Taking the situation of an autonomous vehicle driving on the road as an example, the certain traffic object may be a traffic cone, a ball, a street tree, a vehicle, a construction sign, a person, a vehicle, etc. The disclosure is not limited thereto. In other words, the certain traffic object refers to an object that may appear on the road and may induce a driving behavior by a human driver.

In this embodiment, the object interactive relationship between certain traffic objects may be divided into two types of object interactive relationships. The first type of object interactive relationship records the object interactive relationship between an actual object and a virtual object. Based on the first type of object interactive relationship, the virtual object and the trajectory for the virtual object may be predicted and generated based on the detected actual object. On the other hand, the second type of object interactive relationship records the object interactive relationship between two actual objects. Based on the second type of object interactive relationship, the trajectory of one actual object may be predicted based on another one of the detected two actual objects. In other words, the first type of object interactive relationship may include the object interactive relationship between the virtual object that does not appear in the lane but is predicted to appear because of the actual object appearing on the lane and the actual object. On the other hand, the second type of object interactive relationship may include the object interactive relationship between two actual objects appearing in the lane.

The following will explain the situation that may occur on an actual lane. For example, the object interactive relationship may include, for example, the object interactive relationship between a ball and a person, and the object interactive relationship between a traffic cone/street tree/construction sign and a vehicle, etc. The disclosure is not limited thereto. In this embodiment, the object interactive relationship between the ball (the actual object) and the person (the virtual object) belongs to the first type of object interactive relationship. Generally, when the ball rolls into the lane, there is a possibility that a child (person) chasing the ball and rushing into the lane may appear. Therefore, the interactive relationship database may store the object interactive relationship between the ball and the person as “after the ball is detected, a person with the same path as the ball and moving in m seconds appears after n seconds”, where n and m are preset values. On the other hand, the object interactive relationship between the traffic cone/street tree/construction sign (that is, the actual object) and the vehicle (that is, the actual object) belongs to the second type of object interactive relationship. Generally, when a human driver is driving a vehicle, if the driver sees an obstacle such as a traffic cone/street tree/construction sign in the lane in front of the vehicle, the driver turns to avoid these obstacles. Therefore, the interactive relationship database may store the object interactive relationship between the traffic cone/street tree/construction sign and the vehicle as “when the traffic cone/street tree/construction sign and the vehicle are detected, the driving speed of the vehicle slows down to k kilometers per hour in order for the vehicle to switch lanes when the vehicle is j meters away from the traffic cone/street tree/construction sign”, where j and k are preset values. It is worth noting that driver may encounter other different situations while driving the vehicle, so the disclosure is not limited to the above object interactive relationships. Those skilled in the art should design an object interactive relationship between other certain traffic objects based on the enlightenment of the above-mentioned exemplary embodiment.

In step S208, the processor 110 may determine a trajectory (also known as a first trajectory) for navigating the main vehicle based on the preset interactive relationship information. In this embodiment, the trajectory may include a path and the velocity at each trajectory point in the path. Specifically, the processor 110 may generate a predicted trajectory of a predicted object based on the preset interactive relationship information. Next, the processor 110 may determine the first trajectory of the main vehicle based on the predicted trajectory.

In an embodiment, the processor 110 first determines whether the preset interactive relationship information includes the first type or the second type of object interactive relationship to generate a determination result. Next, the processor 110 may generate the predicted trajectory of the predicted object based on the determination result.

In this embodiment, in response to determining that the preset interactive relationship information includes the first type of object interactive relationship, the processor 110 may obtain the preset object corresponding to the preset interactive relationship information associated with the recognized object from the interactive relationship database 121 based on the object recognized in step S204 as the predicted object. As in the foregoing example, assuming that there is the first type of object interactive relationship between the ball and the person, the processor 110 may obtain the “person” from the interactive relationship database 121 as the predicted object based on the recognized ball. Next, the processor 110 may calculate the predicted trajectory of the object based on the preset interactive relationship information and the trajectory of the recognized object.

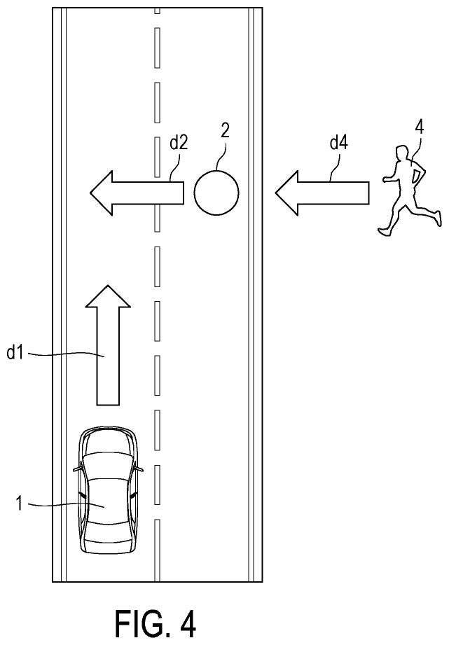

FIG. 4 illustrates a schematic view of an object interactive relationship based on an embodiment of the disclosure. For the convenience of description, FIG. 4 illustrates a schematic view of a main vehicle 1 and other objects mapped onto the lane. In this embodiment, it is assumed that the interactive relationship database 121 stores the preset interactive relationship information “after the ball is detected, a person with the same path as the ball and moving in m seconds appears after n seconds” between the actual object “ball” and the virtual object “person”.

Referring to FIG. 4, the main vehicle 1 of this embodiment is controlled by the processor 110 to drive along a trajectory d1. This trajectory d1 is an original target trajectory of the main vehicle 1. It is assumed that the processor 110 recognizes an object 2 from the certain image frame, and this object 2 is classified as a ball. In this embodiment, the processor 110 obtains the preset interactive relationship information associated with the object 2, “after the ball is detected, a person with the same path as the ball and moving in m seconds appears after n seconds” from the interactive relationship database 121 based on the object 2. Based on the preset interactive relationship information, the interactive relationship between the object 2 and the virtual object “person” is stored in the interactive relationship database 121, so the processor 110 may determine that the preset interactive relationship information associated with the object 2 includes the first type of object interactive relationship. Next, the processor 110 may obtain a preset object 4 corresponding to the preset interactive relationship information associated with the object 2 from the interactive relationship database 121 based on the object 2 as the predicted object. In this embodiment, the preset object 4 is a “person”. Therefore, the processor 110 may calculate a trajectory d4 of the preset object 4 based on the preset interactive relationship information “after the ball is detected, a person with the same path as the ball and moving in m seconds appears after n seconds” and the trajectory d2 of the object 2.

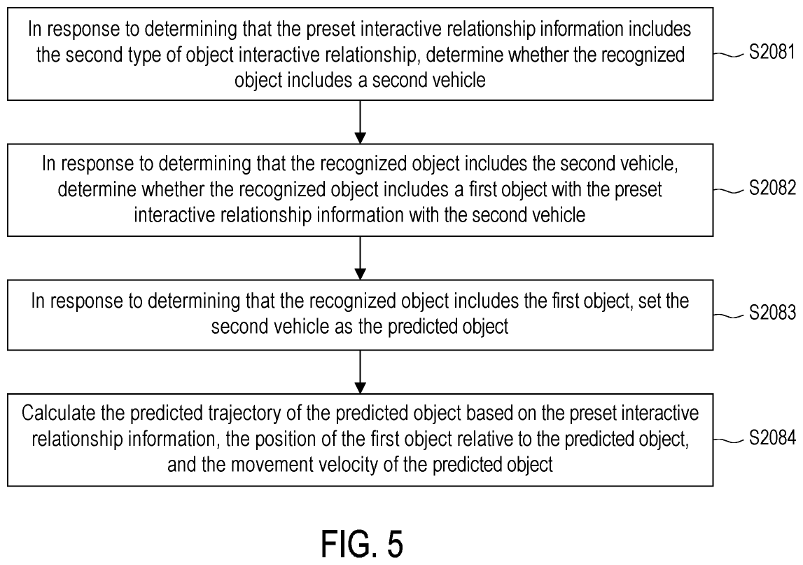

In this embodiment, if the processor 110 determines that the preset interactive relationship information includes the second type of object interactive relationship, the processor 110 may adopt a predicted trajectory generation process different from that for the first type of object interactive relationship. Specifically, referring to FIG. 5, FIG. 5 illustrates a flow chart of a method for predicting a path based on an object interaction relationship based on an embodiment of the disclosure. In step S2081, in response to determining that the preset interactive relationship information includes the second type of object interactive relationship, the processor 110 may determine whether the object recognized in step S204 includes a second vehicle. In step S2082, in response to determining that the recognized object includes the second vehicle, the processor 110 may determine whether the recognized object includes a first object with the preset interactive relationship information with the second vehicle. In step S2083, in response to determining that the recognized object includes the first object, the processor 110 sets the second vehicle as the predicted object. Next, in step S2084, the processor 110 calculates the predicted trajectory of the predicted object based on the preset interactive relationship information, the position of the first object relative to the predicted object, and the movement velocity of the predicted object.

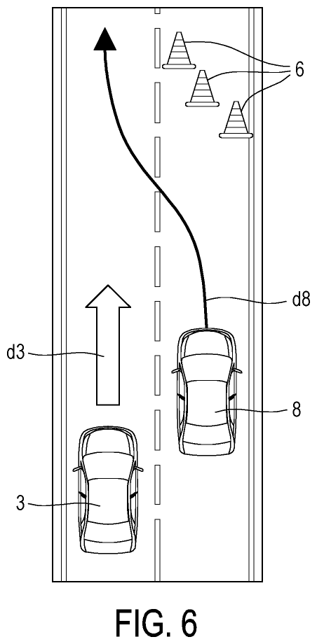

FIG. 6 illustrates a schematic view of an object interactive relationship based on an embodiment of the disclosure. For the convenience of description, FIG. 6 illustrates a schematic view of a main vehicle 3 and other objects mapped onto the lane. In this embodiment, it is assumed that the interactive relationship database 121 stores the preset interactive relationship information “when the traffic cone and the vehicle are detected, the driving speed of the vehicle slows down to k kilometers per hour in order for the vehicle to switch lanes when the vehicle is j meters away from the traffic cone” between the actual object “vehicle” and the actual object “traffic cone”.

Referring to FIG. 6, the main vehicle 3 of this embodiment is controlled by the processor 110 to drive along a trajectory d3, and this trajectory d3 is an original target trajectory of the main vehicle 3. The processor 110 recognizes an object 6 and an object 8 from the certain image frame, and the object 6 is classified as a traffic cone, and the object 8 is classified as a vehicle. In this embodiment, the processor 110 obtains the preset interactive relationship information respectively associated with the object 6 and the object 8 from the interactive relationship database 121 based on the object 6 and the object 8. In this embodiment, the preset interactive relationship obtained by the processor 110 from the interactive relationship database 121 based on the object 6 or the object 8 may include the interactive relationship information between the actual object “vehicle” and the actual object “traffic cone”. Therefore, the processor 110 determines that the preset interactive relationship information associated with the object 6 or the object 8 includes the second type of object interactive relationship. Next, in response to determining that the preset interactive relationship information includes the second type of object interactive relationship, the processor 110 determines whether the recognized object 6 and object 8 include a vehicle. In this embodiment, in response to determining that the recognized object 8 is a vehicle, the processor 110 further determines whether the other recognized objects are objects with the second type of object interactive relationship with the object 8. In this embodiment, the processor 110 may determine that there is the second type of object interactive relationship between the object 6 and the object 8 among the other recognized objects, so the processor 110 sets the object 8 (the vehicle) as the predicted object. In addition, the processor 110 calculates a predicted trajectory d8 of the object 8 based on the preset interactive relationship information “when the traffic cone and the vehicle are detected, the driving speed of the vehicle slows down to k kilometers per hour in order for the vehicle to switch lanes when the vehicle is j meters away from the traffic cone”, the position of the object 6 relative to the object 8, and the movement velocity of the object 8.

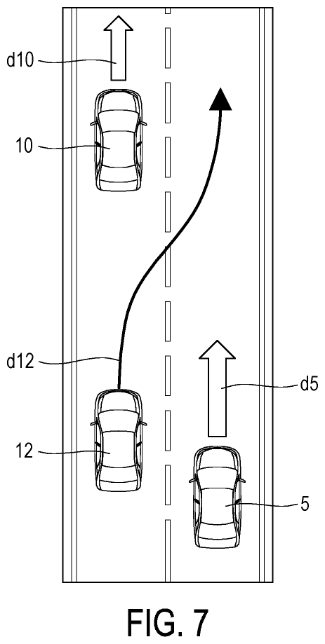

FIG. 7 illustrates a schematic view of an object interactive relationship based on an embodiment of the disclosure. For the convenience of description, FIG. 7 illustrates a schematic view of a main vehicle 5 and other objects mapped onto the lane. In this embodiment, it is assumed that the interactive relationship database 121 stores the preset interactive relationship information “when two vehicles are detected, the following vehicle accelerates to y kilometers per hour when the following vehicle is x meters away from the preceding vehicle to switch lanes” between the actual object “vehicle” and the actual object “vehicle”, where x and y are preset values.

Referring to FIG. 7, the main vehicle 5 of the embodiment is controlled by the processor 110 to drive along a trajectory d5, and this trajectory d5 is an original target trajectory of the main vehicle 5. The processor 110 recognizes an object 10 and an object 12 from the certain image frame, and both the object 10 and the object 12 are classified as vehicles. The object 10 is the preceding vehicle, the object 12 is the following vehicle, and the object 10 is driving along a trajectory d10. In this embodiment, the processor 110 obtains the preset interactive relationship information respectively associated with the object 10 and the object 12 from the interactive relationship database 121 based on the object 10 and the object 12. In this embodiment, the preset interactive relationship information obtained by the processor 110 from the interactive relationship database 121 based on the object 10 or the object 12 may include the interactive relationship between the actual object “vehicle” and the actual object “vehicle”. Therefore, the processor 110 determines that the preset interactive relationship information associated with the object 10 or the object 12 includes the second type of object interactive relationship. Next, in response to determining that the preset interactive relationship information includes the second type of object interactive relationship, the processor 110 determines whether the recognized object 10 and the object 12 include a vehicle. In this embodiment, in response to determining that the recognized object 12 is a vehicle, the processor 110 determines whether the other recognized objects are objects with a second type of object interactive relationship with the object 12. In this embodiment, the processor 110 may determine that there is the second type of object interactive relationship between the object 10 and the object 12 among the other recognized objects, so the processor 110 sets the object 12 (the following vehicle) as the predicted object. In addition, the processor 110 calculates a predicted trajectory d12 of the object 12 based on the preset interactive relationship information “when two vehicles are detected, the following vehicle accelerates to y kilometers per hour when the following vehicle is x meters away from the preceding vehicle to switch lanes”, the position of the object 10 relative to the object 12, and the movement velocity of the object 12.

After the predicted trajectory of the predicted object other than the main vehicle is calculated, the processor 110 determines the first trajectory for navigating the main vehicle based on the predicted trajectory. In an embodiment, the processor 110 may calculate a predicted collision time between a generated predicted trajectory and the original target trajectory of the main vehicle, and adjust the original target trajectory of the main vehicle based on the predicted collision time to generate the first trajectory. For example, the processor 110 adjusts the driving velocity (for example, acceleration and deceleration) or the driving direction (for example, turning) of the main vehicle in the original target trajectory to generate the first trajectory. It is worth noting that the processor 110 may update the path included in the original target trajectory and the velocity at each trajectory point in the path based on the adjusted driving velocity or direction of the main vehicle to generate the first trajectory. In this way, by considering the preset interactive relationship between objects, the embodiment of the disclosure may accurately predict the trajectory of the object around the main vehicle, thereby accurately planning the trajectory for navigating the main vehicle.

Referring to FIG. 4 again, for example, after calculating the trajectory d4 of the object 4, the processor 110 may calculate a predicted collision time t between the trajectory d4 and the trajectory d1 of the main vehicle 1, and reduce the driving velocity of the main vehicle 1 in the trajectory d1 of the main vehicle 1 based on the predicted collision time t. In other words, the processor 110 may reduce the velocity at a specific trajectory point in the trajectory d1 to update the original target trajectory to generate the first trajectory for navigating the main vehicle 1. In this way, the main vehicle 1 may be prevented from colliding with the preset object 4 that may rush out.

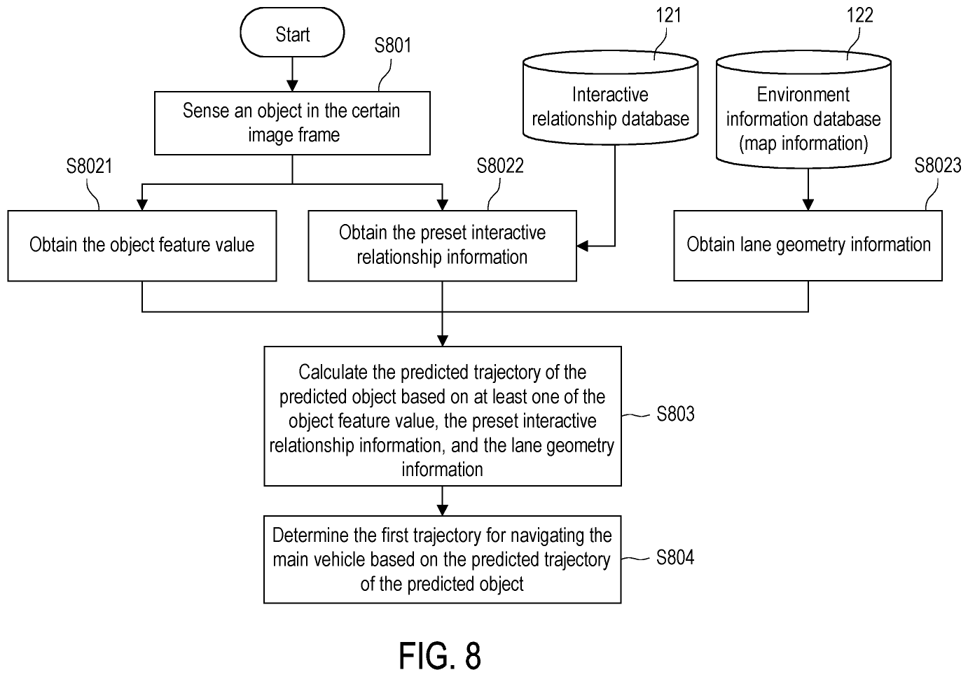

FIG. 8 illustrates a flow chart of a method for predicting a path based on an object interaction relationship based on an embodiment of the disclosure. In an embodiment, the processor 110 may further determine the predicted trajectory of the predicted object based on an object feature value of a surrounding object or surrounding environment information.

Referring to FIG. 8, in step S801, the processor 110 may sense an object in the certain image frame as the predicted object. In step S8021, the processor 110 may perform an image recognition operation on the certain image frame to obtain the object feature value of the predicted object. The object feature value is, for example, the signal of the vehicle's turn signal or the speed of the vehicle. For example, the image recognition operation may be implemented as obtaining the object feature value of the predicted object in the certain image frame by using a pre-established and trained object recognition model, and the disclosure is not limited thereto. In step S8022, the processor 110 may obtain the preset interactive relationship information associated with the object from the interactive relationship database 121 based on the object recognized from the certain image frame. The description of step S206 may be referred to for the detailed implementation of obtaining the preset interactive relationship information, which will not be repeated herein.

In step S8023, the processor 110 may obtain lane geometry information from the environment information database 122 based on positioning data of the main vehicle. The environment information database 122 may store map information, and the map information may include road information and intersection information. The processor 110 may obtain the lane geometry information such as lane reduction and curves from the environment information database 122. Specifically, the electronic apparatus 11 of the embodiment may be further coupled to a positioning device (not shown). The positioning device is, for example, a Global Positioning System (GPS) device, which may receive the positioning data of the current position of the main vehicle, including longitude and latitude data.

In step S803, the processor 110 may calculate the predicted trajectory of the predicted object based on at least one of the object feature value, the preset interactive relationship information, and the lane geometry information. Referring to FIG. 7, assuming that the obtained object feature value of the object 12 is the right signal of the turn signal lighting up, the processor 110 may determine that the object 12 is about to turn right. Here, the processor 110 may calculate the trajectory d12 of the object 12 based on the object feature value. In an example of lane geometry information, assuming that the obtained lane geometry information is reduction of the road ahead, the processor 110 may determine that the predicted object drives towards an unreduced lane when the predicted object is a vehicle. Here, the processor 110 may calculate the trajectory of the predicted object based on the lane geometry information “reduction of the road ahead”.

In step S804, the processor 110 may determine the first trajectory for navigating the main vehicle based on the predicted trajectory of the predicted object. The aforementioned embodiment may be referred to for the specific description of determining the first trajectory, which will not be repeated herein. After the first trajectory is determined, the processor 110 may control the movement of the main vehicle based on the first trajectory.

It is worth noting that each step in FIGS. 2, 5 and 8 and the aforementioned embodiment may be implemented as a plurality of codes or circuits, and the disclosure is not limited thereto. In addition, the methods shown in FIGS. 2, 5, and 8 may be used in connection with the above exemplary embodiment or used alone, and the disclosure is not limited thereto.

In summary, in the method and the electronic apparatus for predicting a path based on an object interaction relationship provided by the embodiment of the disclosure, the predicted trajectory of the predicted object may be generated based on the preset interactive relationship information between the objects. The predicted trajectory is used to determine the trajectory for navigating the main vehicle. In this way, the predicted trajectory of the predicted object is generated by considering the preset interactive relationship between the objects. The disclosure may reduce the trajectory prediction error of the objects around the main vehicle, thereby improving the accuracy of predicting the trajectory of these surrounding objects. In addition, the disclosure may accurately calculate and the predicted trajectory of the predicted object through the object feature values of the surrounding objects and the lane geometry information. Based on the above, the disclosure may accurately plan the trajectory for navigating the main vehicle by effectively predicting the impact of the surrounding objects on the main vehicle.

Although the disclosure has been disclosed in the above by way of embodiments, the embodiments are not intended to limit the disclosure. Those with ordinary knowledge in the technical field can make various changes and modifications without departing from the spirit and scope of the disclosure. Therefore, the protection scope of the disclosure is subject to the scope of the appended claims.

What is claimed is:

1. A method for predicting a path based on an object interaction relationship, adapted for an electronic apparatus comprising a processor, wherein the electronic apparatus is configured to control a first vehicle, and the method comprises:
receiving a video comprising a plurality of image frames;
performing object recognition on a certain image frame among the plurality of image frames to recognize at least one object in the certain image frame;
obtaining preset interactive relationship information associated with the at least one object from an interactive relationship database based on the at least one object; and
determining a first trajectory for navigating the first vehicle based on the preset interactive relationship information.

2. The method for predicting a path based on an object interaction relationship based on claim 1, wherein determining the first trajectory for navigating the first vehicle based on the preset interactive relationship information comprises:
generating a predicted trajectory of a predicted object based on the preset interactive relationship information; and
determining the first trajectory of the first vehicle based on the predicted trajectory.

3. The method for predicting a path based on an object interaction relationship based on claim 2, wherein generating the predicted trajectory of the predicted object based on the preset interactive relationship information comprises:
determining whether the preset interactive relationship information comprises a first type or a second type of object interactive relationship, and generating a determination result; and
generating the predicted trajectory of the predicted object based on the determination result.

4. The method for predicting a path based on an object interaction relationship based on claim 3, wherein generating the predicted trajectory of the predicted object based on the determination result comprises:
in response to determining that the preset interactive relationship information comprises the first type of object interactive relationship, obtaining a preset object corresponding to the preset interactive relationship information from the interactive relationship database based on the at least one object as the predicted object; and
calculating the predicted trajectory of the predicted object based on the preset interactive relationship information and a trajectory of the at least one object.

5. The method for predicting a path based on an object interaction relationship based on claim 3, wherein generating the predicted trajectory of the predicted object based on the determination result comprises:
in response to determining that the preset interactive relationship information comprises the second type of object interactive relationship, determining whether the at least one object comprises a second vehicle;
in response to determining that the at least one object comprises the second vehicle, determining whether the at least one object comprises a first object with the preset interactive relationship information with the second vehicle;
in response to determining that the at least one object comprises the first object, setting the second vehicle as the predicted object; and
calculating the predicted trajectory of the predicted object based on the preset interactive relationship information, a position of the first object relative to the predicted object, and a movement velocity of the predicted object.

6. The method for predicting a path based on an object interaction relationship based on claim 2, wherein determining the first trajectory of the first vehicle based on the predicted trajectory comprises:
calculating a predicted collision time between the predicted trajectory and an original target trajectory of the first vehicle, and adjusting the original target trajectory based on the predicted collision time to generate the first trajectory.

7. The method for predicting a path based on an object interaction relationship based on claim 6, wherein adjusting the original target trajectory based on the predicted collision time to generate the first trajectory comprises:
adjusting a driving velocity of the first vehicle in the original target trajectory based on the predicted collision time to generate the first trajectory.

8. The method for predicting a path based on an object interaction relationship based on claim 6, wherein adjusting the original target trajectory based on the predicted collision time to generate the first trajectory comprises:
adjusting a driving direction of the first vehicle in the original target trajectory based on the predicted collision time to generate the first trajectory.

9. The method for predicting a path based on an object interaction relationship based on claim 2, wherein the method further comprises:
performing an image recognition operation to recognize an object feature value of the predicted object; and
calculating the predicted trajectory of the predicted object based on the object feature value.

10. The method for predicting a path based on an object interaction relationship based on claim 2, wherein the method further comprises:
obtaining lane geometry information from an environment information database based on positioning data of the first vehicle; and
calculating the predicted trajectory of the predicted object based on the lane geometry information.

11. An electronic apparatus, adapted for controlling a first vehicle, wherein the electronic apparatus comprises:
a storage device, storing an interactive relationship database; and
a processor, coupled to the storage device, wherein the processor is configured to:
receive a video comprising a plurality of image frames;
perform object recognition on a certain image frame among the plurality of image frames to recognize at least one object in the certain image frame;
obtain preset interactive relationship information associated with the at least one object from the interactive relationship database based on the at least one object; and
determine a first trajectory for navigating the first vehicle based on the preset interactive relationship information.

12. The electronic apparatus based on claim 11, wherein determining the first trajectory for navigating the first vehicle based on the preset interactive relationship information comprises:
generating a predicted trajectory of a predicted object based on the preset interactive relationship information; and
determining the first trajectory of the first vehicle based on the predicted trajectory.

13. The electronic apparatus based on claim 12, wherein generating the predicted trajectory of the predicted object based on the preset interactive relationship information comprises:
determining whether the preset interactive relationship information comprises a first type or a second type of object interactive relationship, and generating a determination result; and
generating the predicted trajectory of the predicted object based on the determination result.

14. The electronic apparatus based on claim 13, wherein the operation of generating the predicted trajectory of the predicted object based on the determination result comprises:
in response to determining that the preset interactive relationship information comprises the first type of object interactive relationship, obtaining a preset object corresponding to the preset interactive relationship information from the interactive relationship database based on the at least one object as the predicted object; and
calculating the predicted trajectory of the predicted object based on the preset interactive relationship information and a trajectory of the at least one object.

15. The electronic apparatus based on claim 13, wherein the operation of generating the predicted trajectory of the predicted object based on the determination result comprises:
in response to determining that the preset interactive relationship information comprises the second type of object interactive relationship, determining whether the at least one object comprises a second vehicle;
in response to determining that the at least one object comprises the second vehicle, determining whether the at least one object comprises a first object with the preset interactive relationship information with the second vehicle;
in response to determining that the at least one object comprises the first object, setting the second vehicle as the predicted object; and
calculating the predicted trajectory of the predicted object based on the preset interactive relationship information, a position of the first object relative to the predicted object, and a movement velocity of the predicted object.

16. The electronic apparatus based on claim 12, wherein the operation of determining the first trajectory of the first vehicle based on the predicted trajectory comprises:
calculating a predicted collision time between the predicted trajectory and an original target trajectory of the first vehicle, and adjusting the original target trajectory based on the predicted collision time to generate the first trajectory.

17. The electronic apparatus based on claim 16, wherein the operation of adjusting the original target trajectory based on the predicted collision time to generate the first trajectory comprises:
adjusting a driving velocity of the first vehicle in the original target trajectory based on the predicted collision time to generate the first trajectory.

18. The electronic apparatus based on claim 16, wherein the operation of adjusting the original target trajectory based on the predicted collision time to generate the first trajectory comprises:
adjusting a driving direction of the first vehicle in the original target trajectory based on the predicted collision time to generate the first trajectory.

19. The electronic apparatus based on claim 12, wherein the processor is further configured to:
perform an image recognition operation to recognize an object feature value of the predicted object; and
calculate the predicted trajectory of the predicted object based on the object feature value.

20. The electronic apparatus based on claim 12, wherein the storage device stores an environment information database, and the processor is further configured to:
obtain lane geometry information from the environment information database based on positioning data of the first vehicle; and
calculate the predicted trajectory of the predicted object based on the lane geometry information.
